(19) United States
(12) Patent Application Publication
(10) Pub. No.: US 2018/0032748 A1
(43) Pub. Date: Feb. 1, 2018

(54) MOBILE DEVICE PHOTO DATA PRIVACY

(71) Applicant: International Business Machines Corporation, Armonk, NY (US)

(72) Inventors: Erik Rueger, Mainz (DE); Matthias Seul, Kassel (DE); Thomas A. Snellgrove, Wakefield, MA (US); Neil Sondhi, Pilisborosjeno (HU)

(21) Appl. No.: 15/224,265

(22) Filed: Jul. 29, 2016

(51) Int. Cl. G06F 21/62; H04L 29/06; G06K 9/18; H04L 9/32; H04N 7/18

(52) U.S. Cl. CPC G06F 21/6218; H04L 9/3231; H04N 7/185; G06K 9/18; H04L 63/20

(57) ABSTRACT

A computer-implemented method according to one embodiment includes identifying a photograph taken utilizing a mobile device, analyzing a plurality of privacy factors associated with the photograph, and performing one or more security actions, based on the analyzing, including determining and presenting to a user of the mobile device a plurality of security options.

### BACKGROUND

The present invention relates to data security, and more specifically, this invention relates to performing automated photograph analysis and associated actions.

In today's world, data transfer and synchronization has become inexpensive and reliable. Many people have automatic syncing with cloud services on by default and at a certain point stop thinking consciously about it. This convenience and speed may become an issue if human absentmindedness and/or malicious intent are involved.

For example, a smartphone device with a camera, high speed network connection, and always-on cloud photo syncing may cause one or more negative occurrences. Additionally, the user may realize their mistake too late, after everything has already been synced and published.

### SUMMARY

A computer-implemented method according to one embodiment includes identifying a photograph taken utilizing a mobile device, analyzing a plurality of privacy factors associated with the photograph, and performing one or more security actions, based on the analyzing, including determining and presenting to a user of the mobile device a plurality of security options.

According to another embodiment, a computer program product for implementing photo data privacy on a mobile device comprises a computer readable storage medium having program instructions embodied therewith, wherein the computer readable storage medium is not a transitory signal per se, and where the program instructions are executable by a processor to cause the processor to perform a method comprising identifying, utilizing the processor, a photograph taken utilizing the mobile device, analyzing, utilizing the processor, a plurality of privacy factors associated with the photograph, and performing, utilizing the processor, one or more security actions, based on the analyzing, including determining and presenting to a user of the mobile device a plurality of security options.

A system according to another embodiment includes a processor and logic integrated with and/or executable by the processor, where the logic is configured to identify a photograph taken utilizing a mobile device, analyze a plurality of privacy factors associated with the photograph, and perform one or more security actions, based on the analysis, including determining and presenting to a user of the mobile device a plurality of security options.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 illustrates a method for implementing mobile device photo data privacy, in accordance with one embodiment.

FIG. 5 illustrates an exemplary photo data privacy system of a mobile device, in accordance with one embodiment.

FIG. 6 illustrates an exemplary data privacy rule set, in accordance with one embodiment.

FIG. 7 illustrates a method for analyzing a photograph and reacting to the analysis, in accordance with one embodiment.

FIG. 8 illustrates an exemplary user notification, in accordance with one embodiment.

### DETAILED DESCRIPTION

The following description discloses several preferred embodiments of systems, methods and computer program products for implementing mobile device photo data privacy. Various embodiments provide a method to automatically intercept and analyze photographs and react according to one or more predetermined criteria.

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “includes” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for implementing mobile device photo data privacy.

In one general embodiment, a computer-implemented method includes identifying a photograph taken utilizing a mobile device, analyzing a plurality of privacy factors associated with the photograph, and performing one or more security actions, based on the analyzing, including determining and presenting to a user of the mobile device a plurality of security options.

In another general embodiment, a computer program product for implementing photo data privacy on a mobile device comprises a computer readable storage medium having program instructions embodied therewith, wherein the computer readable storage medium is not a transitory signal per se, and where the program instructions are executable by a processor to cause the processor to perform a method comprising identifying, utilizing the processor, a photograph taken utilizing the mobile device, analyzing, utilizing the processor, a plurality of privacy factors associated with the photograph, and performing, utilizing the processor, one or more security actions, based on the analyzing, including determining and presenting to a user of the mobile device a plurality of security options.

In another general embodiment, a system includes a processor and logic integrated with and/or executable by the processor, where the logic is configured to identify a photograph taken utilizing a mobile device, analyze a plurality of privacy factors associated with the photograph, and perform one or more security actions, based on the analysis, including determining and presenting to a user of the mobile device a plurality of security options.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

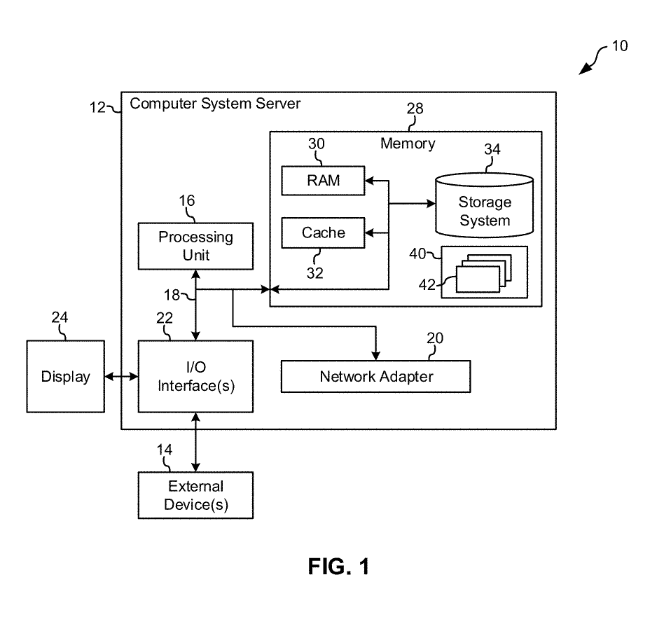

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

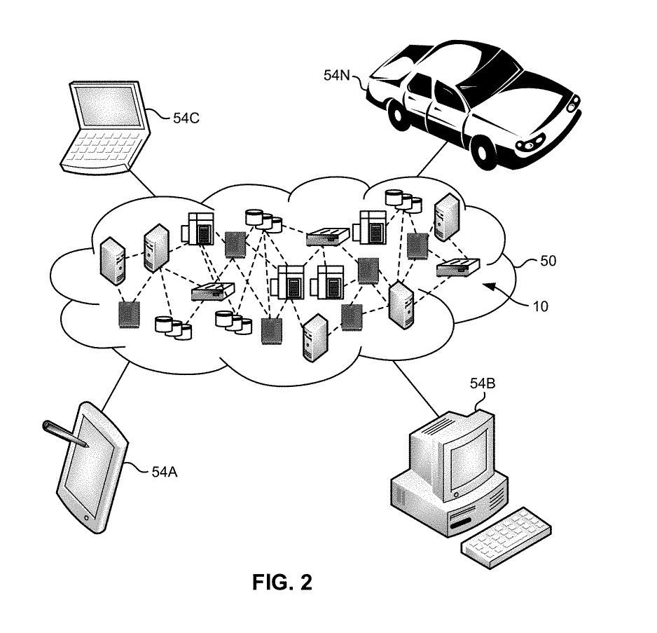

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

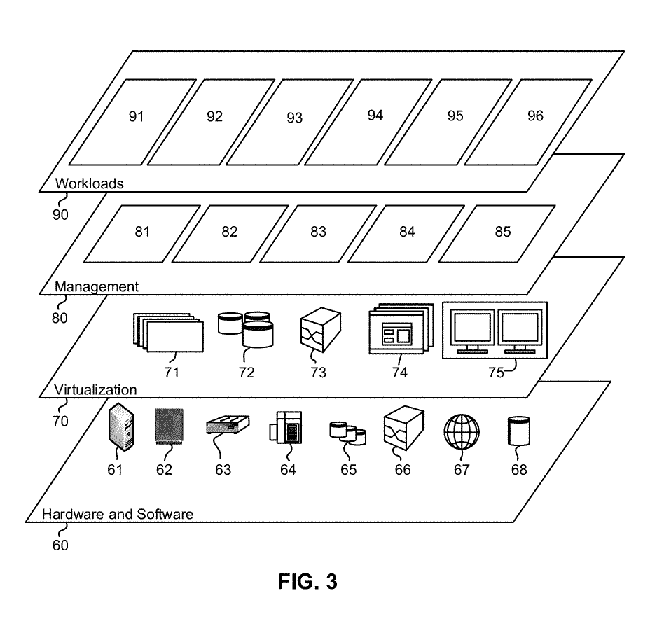

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and photograph analysis and management 96.

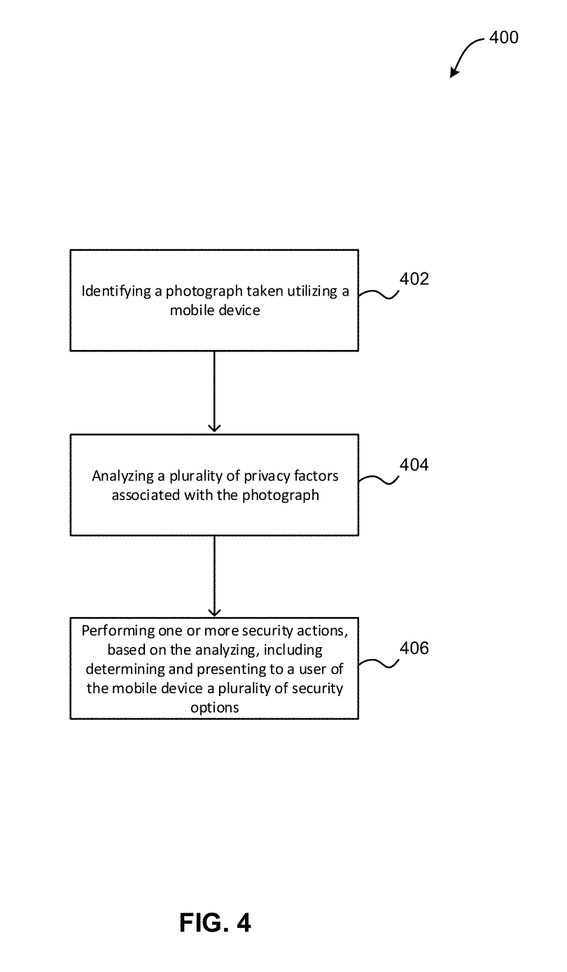

Now referring to FIG. 4, a flowchart of a method 400 is shown according to one embodiment. The method 400 may be performed in accordance with the present invention in any of the environments depicted in FIGS. 1-3 and 5-8, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a photograph taken utilizing a mobile device is identified. In one embodiment, the photograph may include any image created utilizing the mobile device. For example, the photograph may be taken utilizing a camera (e.g., one or more photo sensors, etc.) of the mobile device. In another embodiment, the photograph may be received from hardware of the mobile device. For example, the photograph may be received from photo sensor hardware of the mobile device.

Additionally, in one embodiment, the photograph may be intercepted before being sent to one or more sharing modules of the mobile device (e.g., a social media application, public cloud storage, a personal website, etc.). In another embodiment, the photograph may be temporarily stored in a secure location on the mobile device or off the mobile device (e.g., a secure cloud location) when the photograph is identified. In another embodiment, the photograph may be received by one or more of a hardware and software module. For example, the photograph may be received by a software application of the mobile device, a hardware element of the mobile device, a system including a computing device connected to the mobile device via a communications network, etc.

Further, as shown in FIG. 4, method 400 may proceed with operation 404, where a plurality of privacy factors associated with the photograph are analyzed. In one embodiment, the plurality of privacy factors may include the results of an analysis of the photograph itself (e.g., using image analysis, etc.). In another embodiment, the privacy factors may include textual results of performing optical character recognition (OCR) on text located in the photograph. In yet another embodiment, the privacy factors may include metadata associated with the photograph. For example, the privacy factors may include location data, time data, or other data stored by the mobile device in association with the photograph.

Further still, in one embodiment, the privacy factors may include user data associated with the mobile device. For example, the privacy factors may include data used by one or more applications within the device (e.g., address book data, calendar data, time data, etc.). In another example, the privacy factors may include user-specific information.

Also, in one embodiment, the privacy factors may include the results of a user privacy survey. For example, the privacy factors may include the results of a voluntary survey given to the user, where a user contextualizes and identifies one or more entities (e.g. a home address, a work address, etc.).

In addition, in one embodiment, the privacy factors may be compared to one or more predetermined rules (e.g., one or more predetermined policies, etc.). In another example, the results of comparing the privacy factors to one or more predetermined rules may include a risk score. In another embodiment, risk scores may be calculated for a plurality of different topics (e.g., personal privacy, etc.). In yet another embodiment, the calculated risk scores for the plurality of different topics may be aggregated to determine an overall risk score. In yet another embodiment, the risk score may be identified for the user who took the photograph, the user who owns the mobile device on which the photograph was taken, etc.

Furthermore, in one embodiment, the calculated risk score may include an aggregation of risk scores obtained as a result of the comparison of the privacy factors to a plurality of policies (e.g., personal policies, etc.). Further still, in one embodiment, the calculated risk score may also consider cognitive adjustments made from historical user data. For example, stored user feedback (e.g., user actions taken in response to past analysis results, and suggestions, etc.) may change the calculated risk score and/or security actions performed in response to the analyzing of the plurality of privacy factors. In another example, the stored user feedback may include the results of past photograph analysis and actions taken by a system and/or the user in response to the analysis.

In addition, as shown in FIG. 4, method 400 may proceed with operation 406, where one or more security actions are performed, based on the analyzing, including determining and presenting to a user of the mobile device a plurality of security options. In one embodiment, the security actions may be based on a comparison of the risk score to one or more thresholds (e.g., predetermined security thresholds, etc.). For example, if a predetermined security threshold is exceeded, one or more security actions may be performed.

Additionally, in one embodiment, one or more security actions may be performed based on one or more privacy factors violating one or more predetermined rules. For example, if one or more predetermined rules are violated by one or more privacy factors, one or more security actions may be performed. In another embodiment, cognitive adjustments made from historical user data may be used to determine the one or more security actions to be performed.

Further, in one embodiment, the one or more security actions may include requesting consent from a user and/or an owner of the mobile device. In another embodiment, the one or more security actions may include erasing the photograph automatically and notifying the user. In yet another embodiment, the one or more security actions may include capturing the photograph (e.g., storing the photograph in a secure area on or off of the mobile device, etc.) and notifying the user.

Further still, in one embodiment, the one or more security actions may include passing the photograph to another entity within or separate from the mobile device (e.g., a social media module, a storage cloud, an automatically performed application and/or action, etc.). In another embodiment, each of the security options may include a request for an action from the user. For example, the security options may ask the user whether they want to send the photograph to a storage cloud, send the photograph to social media, store the photograph securely, erase the photograph, etc.

Also, in one embodiment, the one or more security actions may include obscuring a portion of the photograph. For example, one or more of the plurality of privacy factors that violate one or more predetermined policies may be associated with a portion of the photograph, and the portion may be obfuscated in response to the violation determination.

In this way, intelligent assistance may be automatically provided to safeguard user privacy when photographs are taken using a mobile device of the user.

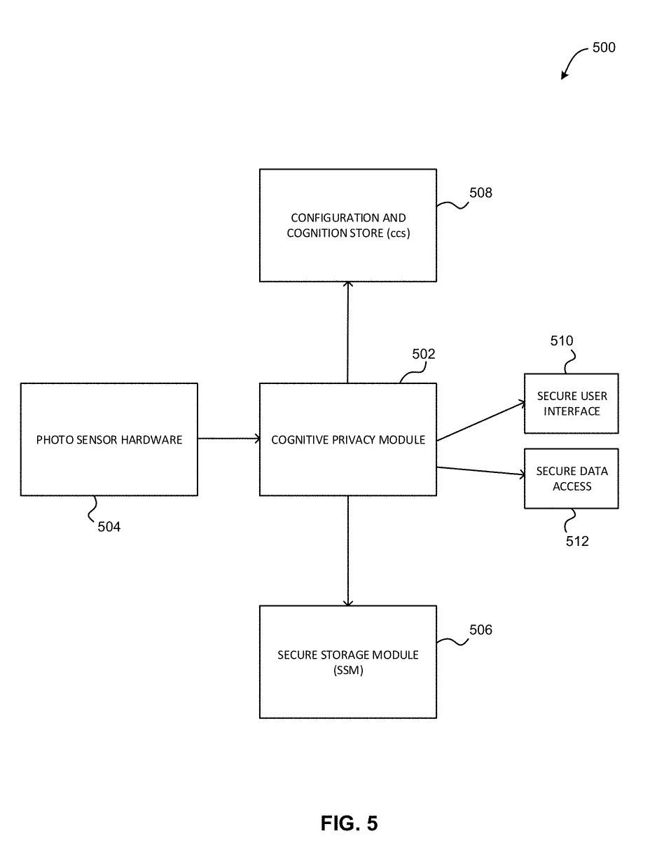

FIG. 5 illustrates an exemplary photo data privacy system 500 of a mobile device, according to one embodiment. In one embodiment, the exemplary photo data privacy system 500 may be integrated in any kind of device capable of taking photographs (e.g., a smart phone, a tablet computer, a camera with wireless communication capabilities, etc.). As shown, the system 500 includes a hardware and/or software implemented cognitive privacy module 502 that is in communication with photo sensor hardware 504.

In one embodiment, photo sensor hardware 504 may create external image information. For example, the photo sensor hardware 504 may be included within a camera of the mobile device and may create external image information in association with a lens and/or one or more applications of the mobile device. In another example, the cognitive privacy module 502 may interface with one or more camera applications of an operating system (OS) of the device.

Additionally, the cognitive privacy module 502 is in communication with a secure storage module (SSM) 506 (e.g., a battery backed random access memory (RAM), a flash memory, etc.), as well as a configuration and cognition store (CCS) 508 which may include a storage module (e.g., RAM, flash memory, etc.) that is physically separate from the mobile device (e.g., to increase security, etc.).

Further, the cognitive privacy module 502 implements a secure user interface 510 to interact with the user. For example, the secure user interface 510 may be used to provide a user of the mobile device with information, to receive consent or other input from the user, etc. Further still, the cognitive privacy module 502 implements secure data access 512. In one embodiment, the secure data access 512 may be used to receive new configuration files, allow access to the SSM 506, etc. In one embodiment, the contents of the SSM 506 may not be backed up to cloud storage.

In one embodiment, the cognitive privacy module 502 may act as a gatekeeper device. In another embodiment, the image processing itself and elements performed by the cognitive privacy module 502 may be performed in the cloud, utilizing a secure transmission procedure. This may allow for greater processing power, more frequent image database updates, for the privacy capability to be provided as a service across multiple photo capture devices, etc.

Further still, in one embodiment, the cognitive privacy module 502 may be triggered by the device (e.g., one or more OS camera functions of the device, etc.) and may in turn communicate (e.g., control, receive data from, etc.) the photo sensor hardware 504. In another embodiment, once the photo sensor hardware 504 signals an image has been captured it may be sent to the cognitive privacy module 502 for analysis. For example, this sending may be done as a transaction, as a stream, etc.

Also, in one embodiment, incoming photograph material may be analyzed by the cognitive privacy module 502 as the data comes in. For example, the cognitive privacy module 502 may differentiate between the camera being in finder mode (e.g., not active recording pictures) and recording mode. In another example, the cognitive privacy module 502 may choose to degrade quality in finder mode or use streaming-based filtering to react to content as it is captured by the camera, even if not for permanent storage.

In addition, in one embodiment, the captured image or stream may be checked by the cognitive privacy module 502 against a database of non-reversible pattern signatures for image recognition. These patterns may encompass objects, people, words, etc. Additional filtering such as OCR may be applied by the cognitive privacy module 502 (e.g., if textual data is identified, etc.). In another embodiment, signatures may be applied by the cognitive privacy module 502 to the captured image and checked for the probability of a match. This match probability may be multiplied by the signature's risk score and number of total potential matches, which may lead to an overall risk score for the photo.

Further, a plurality of different types of data may be analyzed for a photograph by the cognitive privacy module 502 and the types may be combined to generate probability and risk scores. For example, one type of data may include what can be learned from the photographs themselves. This may include several data sub-types including data retrieved via one or more of image analysis, text analysis, and photo metadata analysis.

For example, image analysis may include comparing a photograph to a database of potentially undesirable image types in order to determine whether photos contain potentially undesirable images. In one embodiment, a cloud analytics service may dynamically expand the image database over time.

Further still, in one embodiment, text analysis may include using optical character recognition (OCR) to convert text to characters when image analysis indicates that text is present in a photograph. In another embodiment, OCR text may be compared with multiple dictionaries of potentially undesirable text. In yet another embodiment, a cloud analytics service may dynamically expand text dictionaries over time. In still another embodiment, dictionary types might include one or more OCR dictionaries of undesirable terms.

Also, in one embodiment, photo metadata analysis may include an analysis of metadata included in the photograph (e.g., when the photograph was taken, etc.), and may include one or more of a location where the photograph was taken, a date the photograph was taken, a time the photograph was taken, etc.

Additionally, in one embodiment, the cognitive privacy module 502 may, with the user's permission, also make use of ambient user data. For example, sources of ambient data may include one or more of smartphone contacts, a smartphone calendar, social network information (e.g. a list of social media friends and their photos), etc.

Further, in one embodiment, the cognitive privacy module 502 may also utilize the results of a privacy and/or preferences survey. For example, the photo data privacy system 500 may gain data context via a privacy and/or preferences survey. In one embodiment, the survey may be optional, and survey questions may include one or more of a list of contacts and/or photos to exclude, an indication of text to exclude, one or more geo-fence definitions for common areas (e.g., work, home, school, gym, etc.), etc.

Further still, in one embodiment, the overall risk score may be on a single axis (e.g., “risk,” etc.) or may have multiple dimensions (e.g., “personal privacy,” etc.) which may be calculated separately and/or added up to a total risk score.

In this way, the photo data privacy system 500 may intercept photographic data and check it for certain persons, locations, shapes and objects that might be deemed risky. This riskiness may be determined by loading the chip's memory with non-reversible, fuzzy signatures of the to-be-protected targets, assigning risk scores to said signatures and applying dynamic, cascading policies to handle incoming photographic data. These policies may withhold certain pictures until consent it received by the user, block/erase photographs automatically, and/or prevent photographs from leaving the mobile device.

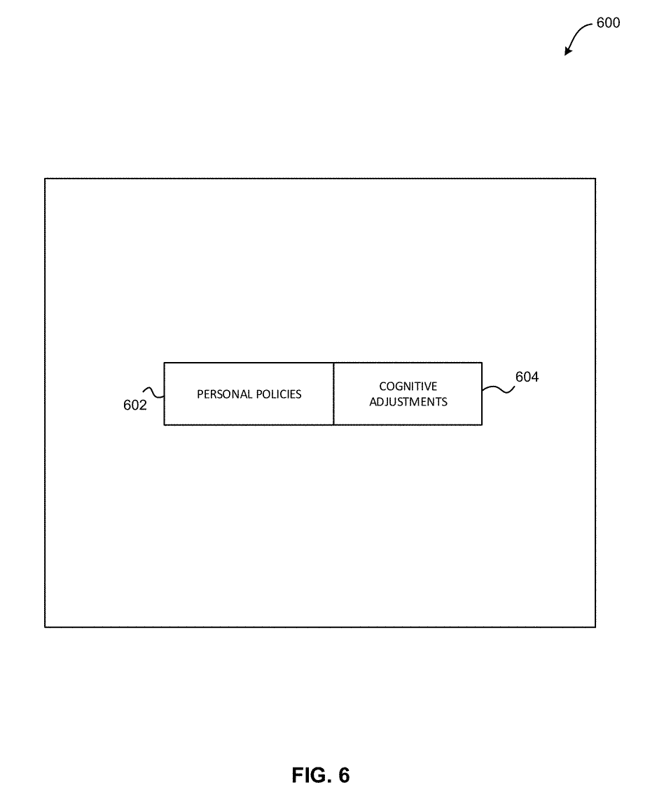

FIG. 6 illustrates an exemplary data privacy rule set 600, in accordance with one embodiment. As shown, the rule set 600 includes user-specific personal policies 602 that are amended with cognitive adjustments 604. In one embodiment, based on aggregated risk and/or individual risk dimensions identified by a cognitive privacy module, the cognitive privacy module may decide how to react upon a captured photograph.

Additionally, in one embodiment, the user-specific personal policies 602 may include one or more rules implemented by the user of a mobile device. For example, the user may specify the user-specific personal policies 602 utilizing a graphical user interface (GUI) implemented by the cognitive privacy module of the mobile device.

Further, the personal policies 602 are improved directly on a device utilizing cognitive adjustments 604 derived utilizing cognitive learning. For example, the cognitive privacy module may process feedback gathered from consent dialogs sent to the user as well as behavior observed in other applications (e.g., if the applications agree to share their info with the cognitive privacy module, etc.). In another example, the cognitive privacy module may learn from past user choices to see which consent choice is taken depending on the underlying risk levels.

Further still, in one embodiment, the cognitive privacy module may also learn from the signatures present for a given photo and the resulting choice of the user. In another embodiment, the cognitive privacy module may try to analyze visual images on its own to build new patterns. For example, the cognitive privacy module may be equipped with algorithms that allow it to focus on specific patterns, extract them into a non-reversible signature and then send this signature into the cloud for (fuzzy) matching with other signatures.

Also, in one embodiment, one or more systems (e.g., the cognitive privacy module, the mobile device, a remote policy decision module separate from the mobile device, etc.) may evaluate the data privacy rule set 600. Similar to a firewall, the one or more systems may check if a given risk is present and at which magnitude, and may then execute an associated action.

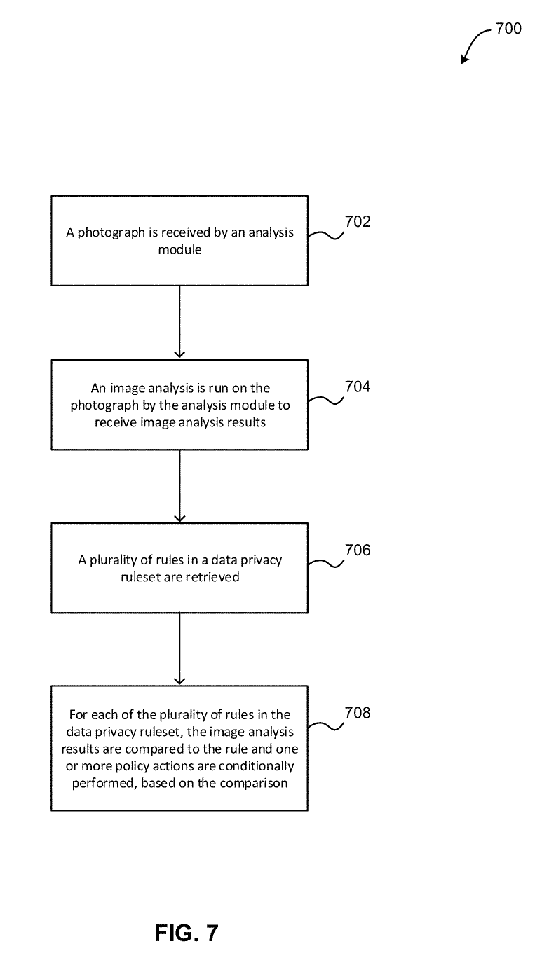

Now referring to FIG. 7, a flowchart of a method 700 for analyzing a photograph and reacting to the analysis is shown according to one embodiment. The method 700 may be performed in accordance with the present invention in any of the environments depicted in FIGS. 1-6 and 8, among others, in various embodiments. Of course, more or less operations than those specifically described in FIG. 7 may be included in method 700, as would be understood by one of skill in the art upon reading the present descriptions.

Each of the steps of the method 700 may be performed by any suitable component of the operating environment. For example, in various embodiments, the method 700 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 700. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 7, method 700 may initiate with operation 702, where a photograph is received by an analysis module. Additionally, method 700 may proceed with operation 704, where an image analysis is run on the photograph by the analysis module to receive image analysis results. In one embodiment, the image analysis may be run on the photograph to identify one or more privacy factors associated with the photograph.

Further, method 700 may proceed with operation 706, where a plurality of rules in a data privacy ruleset are retrieved. In one embodiment, the plurality of rules may include user-specific personal policies that are amended with cognitive adjustments. Further still, method 700 may proceed with operation 708, where for each of the plurality of rules in the data privacy ruleset, the image analysis results are compared to the rule and one or more policy actions are conditionally performed, based on the comparison.

In one embodiment, if the comparison returns no relevant indicators (e.g., the comparison indicates that none of the plurality of rules are triggered, etc.), the photograph may be delivered to a requesting application without any interruption. In another embodiment, if one or more rules have been triggered as a result of the comparison, but one or more thresholds associated with those one or more rules have not been exceeded, no action may be taken. For example, the photograph may be delivered to a requesting application without interruption. In another example, a notification may be displayed to the user (e.g. to notify the user that one or more rules were triggered but not violated, etc.).

Also, in one embodiment, if one or more rules have been triggered as a result of the comparison, and one or more thresholds associated with those one or more rules have been exceeded, the photograph may be stored in a secure storage area (e.g., a secure storage module, etc.). In another embodiment, a thumbnail of the picture having a low quality (e.g., 64×64px, etc.) may be generated. In yet another embodiment, a consent request for the user may be directly or indirectly (e.g., through a supported application, etc.) triggered. For example, the consent request may display one or more of a time the photograph was taken, the generated thumbnail, a reason of intervention (e.g., a specific description of a rule that was triggered and violated, etc.).

In addition, in one embodiment, the consent request may include one or more options for the user to select. For example, the user may be provided with an option to deliver the photograph normally, an option to deny cloud syncing, an option to keep the photograph on the SSM without delivering it, an option to erase the photograph, etc. In another embodiment, the consent request may include a time lock that may prevent any attempt to share the photo for a predetermined time period (e.g., a set number of hours, etc.).

Furthermore, in one embodiment, if one or more rules have been triggered as a result of the comparison, and one or more thresholds associated with those one or more rules have been exceeded, the received photograph may be stored in a secure storage area and may not be delivered to a requesting app. In another embodiment, if one or more rules have been triggered as a result of the comparison, and one or more thresholds associated with those one or more rules have been exceeded, the received photograph may be automatically discarded and secure erased, and may not be delivered to the requesting app.

Further still, in one embodiment, one or more of the plurality of rules may include default rules which may be customized by the user. For example, one or more rules may be universal and may cover one or more predetermined scenarios.

Table 1 illustrates exemplary default rules, in accordance with one embodiment. Of course, it should be noted that the default rules shown in Table 1 are set forth for illustrative purposes only, and thus should not be construed as limiting in any manner.

### Table 1

Photos of objectionable imagery=>Capture & Store
Any photo taken in a location that differs significantly from the location listed in the user's calendar for the same date and time=>Capture & Store
Photos taken between midnight and 5 am local time=>Request Consent (with time lock)

In one embodiment, a determination whether or not a photo is deemed objectionable or not may be based on context. In another embodiment, the analysis results may be used to create one or more scenarios, and specific rules may be applied depending on the scenario. In yet another embodiment, default rules may be provided but may be customized by an end user. In this way, an analysis module may automatically analyze taken photographs and may dynamically respond with one or more actions based on the analysis.

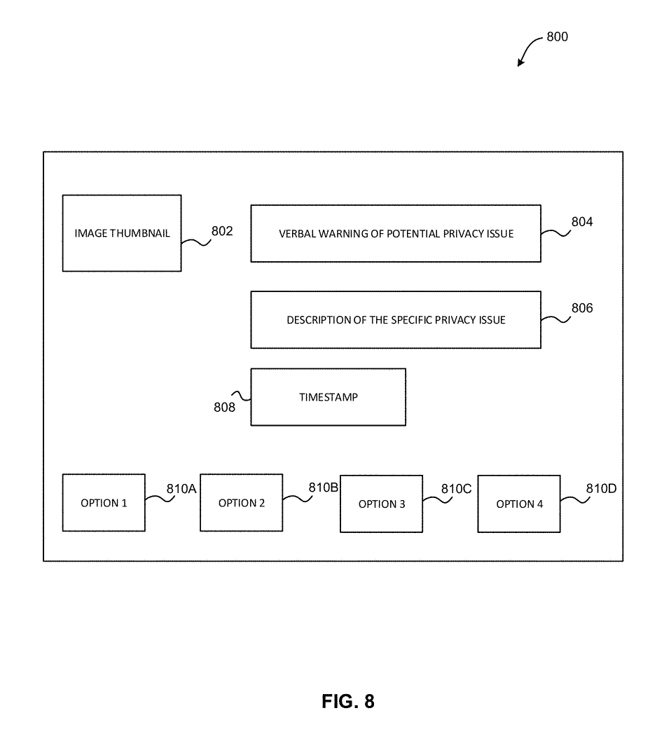

FIG. 8 illustrates an exemplary user notification 800, in accordance with one embodiment. In one embodiment, the user notification 800 may be presented to a user utilizing a graphical user interface (GUI) of a device. As shown, the user notification 800 includes a thumbnail 802 of an image taken by a user using a mobile device. Additionally, the user notification 800 includes a verbal warning 804 of a potential privacy issue associated with the taken photograph, as well as a description 806 of the specific privacy issue and a timestamp 808 indicating a time that the privacy issue was detected. Additionally, the user notification 800 includes a plurality of options 810A-D for selection by a user, where each of the plurality of options 810A-D summarizes an action to be taken to remedy the potential privacy issue.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer-implemented method, comprising:
identifying a photograph taken utilizing a mobile device;
analyzing a plurality of privacy factors associated with the photograph; and
performing one or more security actions, based on the analyzing, including determining and presenting to a user of the mobile device a plurality of security options.

2. The computer-implemented method of claim 1, wherein the photograph is intercepted before being sent to one or more sharing modules of the mobile device.

3. The computer-implemented method of claim 1, further comprising temporarily storing the photograph in a secure location on the mobile device or off the mobile device.

4. The computer-implemented method of claim 1, wherein the plurality of privacy factors include results of an analysis of the photograph using image analysis.

5. The computer-implemented method of claim 1, wherein the plurality of privacy factors include textual results of performing optical character recognition (OCR) on text located in the photograph.

6. The computer-implemented method of claim 1, wherein the plurality of privacy factors include metadata associated with the photograph.

7. The computer-implemented method of claim 1, wherein the plurality of privacy factors include user data associated with the mobile device.

8. The computer-implemented method of claim 1, wherein the plurality of privacy factors include results of a user privacy survey.

9. The computer-implemented method of claim 1, wherein the one or more security actions are performed when on one or more of the privacy factors violate one or more predetermined rules.

10. The computer-implemented method of claim 1, wherein performing the one or more security actions include requesting consent from a user of the mobile device.

11. A computer program product for implementing photo data privacy on a mobile device, the computer program product comprising a computer readable storage medium having program instructions embodied therewith, wherein the computer readable storage medium is not a transitory signal per se, the program instructions executable by a processor to cause the processor to perform a method comprising:
identifying, utilizing the processor, a photograph taken utilizing the mobile device;
analyzing, utilizing the processor, a plurality of privacy factors associated with the photograph; and
performing, utilizing the processor, one or more security actions, based on the analyzing, including determining and presenting to a user of the mobile device a plurality of security options.

12. The computer program product of claim 11, wherein the photograph is intercepted before being sent to one or more sharing modules of the mobile device.

13. The computer program product of claim 11, further comprising temporarily storing the photograph in a secure location on the mobile device or off the mobile device, utilizing the processor.

14. The computer program product of claim 11, wherein the plurality of privacy factors include results of an analysis of the photograph using image analysis.

15. The computer program product of claim 11, wherein the plurality of privacy factors include textual results of performing optical character recognition (OCR) on text located in the photograph.

16. The computer program product of claim 11, wherein the plurality of privacy factors include metadata associated with the photograph.

17. The computer program product of claim 11, wherein the plurality of privacy factors include user data associated with the mobile device.

18. The computer program product of claim 11, wherein the plurality of privacy factors include results of a user privacy survey.

19. The computer program product of claim 11, wherein the one or more security actions are performed when on one or more of the privacy factors violate one or more predetermined rules.

20. A system, comprising:
a processor and logic integrated with and/or executable by the processor, the logic being configured to:
identify a photograph taken utilizing a mobile device;
analyze a plurality of privacy factors associated with the photograph; and
perform one or more security actions, based on the analysis, including:
determine and present to a user of the mobile device a plurality of security options.
